(19) United States
(12) Patent Application Publication
(10) Pub. No.: US 2004/0099695 A1
(43) Pub. Date: May 27, 2004

(54) Chargeable fluid dispensing kit

(76) Inventor: Clifford J. Finn, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 10/306,145

(22) Filed: Nov. 27, 2002

(51) Int. Cl. B67D 5/42

(52) U.S. Cl. 222/386.5; 222/389

(57) ABSTRACT

A chargeable portable fluid dispensing kit is not subject to all hazardous material regulations, and can dispense fluid in any orientation. In one embodiment, the kit includes a cylinder defining a total volume, and having a flexible diaphragm dividing the total volume into a dispensing fluid containing volume and a pressure volume. The cylinder has a first valve outside of the cylinder and in fluid communication with the dispensing fluid containing volume, and the cylinder has a second valve outside of the cylinder and in fluid communication with the pressure volume. Advantageously, a fluid can be introduced into the pressure volume through the second valve to increase the pressure in the total volume for dispensing a dispensing fluid disposed in the fluid dispensing volume through the first valve.

### CROSS REFERENCES TO RELATED APPLICATIONS

Not Applicable

### STATEMENT REGARDING FEDERALLY SPONSORED RESEARCH

Not Applicable

### BACKGROUND OF THE INVENTION

The invention relates generally to a fluid dispensing kit and more particularly to a fluid dispensing kit containing a pressure chargeable cylinder containing a dispensing fluid.

There are numerous applications in which a dispensing fluid, such as a sprayable adhesive, fire retardant, insulation, sealant, and the like, is used at a site for any number of applications. For example, a dispensing fluid comprising a polyurethane foam is used with increasing frequency as a sealant in the building trades for sealing spaces between window and door frames. The foam is also used as an adhesive for gluing flooring and roof tiles. The polyurethane foam for such in situ applications is typically supplied as a one-component froth foam or a two-component froth foam.

A one-component foam includes a dispensing fluid comprising both a resin and isocyanate. The fluid is supplied in a single pressurized container, and is dispensed from the container through a valve or gun attached to the container. A one-component foam is simple to use. Unfortunately, however, one-component foams have a short shelf life because the resin and isocyanate react over time in the single container.

A two-component “froth” foam provides the foam components in separate containers. One component, such as polymeric isocyanate, fluorocarbons, and the like, is supplied in one pressurized container, while the other component, typically a resin, such as polyols, catalyst, flame retardants, and the like, is supplied in a second pressurized container. The components in the two component kit are typically dispensed simultaneously through a dispensing gun connected to both cylinders by hoses. The dispensing gun mixes the components as they are dispensed.

Typically, two-component kits use pressurized cylinders 6″ to 10″ in diameter which are connected by the hoses to the dispensing gun. Generally, the cylinders weigh anywhere from 15 to about 30 lbs. and are pressurized with a pressurizing gas at pressures of about 200 psi gage at ambient temperature, 70° F. prior to shipping. The pressurizing gas mixes with the components in the cylinders, and must be an inert gas, such as nitrogen, that will not react with the dispensing fluid. One of the advantages of the two-component system is its relatively long shelf life resulting from the fact that the chemicals are not mixed until they encounter one-another in the dispensing gun.

A two-component kit typically includes the two cylinders, each containing one of the foam components, the dispensing gun and hoses connecting the cylinders to the gun. These items are generally packaged in a cardboard container, box or carton and the carton is then used to hand carry the items to the site where the foam is to be dispensed. Because the chemicals contained within the cylinders are under a high pressure (i.e. greater than 40 psig), they are deemed hazardous material. Accordingly, the carton must house the cylinders in such a manner that extensive safety regulations are complied with during shipping. Complying with these safety regulations increases the costs of the kit, and limits available modes of shipping.

A typical container for a two-component kit is a cardboard, fold-out box with a separate cardboard tray. The tray fits over the valved ends of the cylinders to hold the cylinders in place in the box during shipment and is integrated into the box such as by folding flaps fitting into tray slots at the box end adjacent the tray. The tray holds the cylinders and the box flaps hold the tray to the box. In the top of the tray, the hoses are placed in a coiled manner with the dispensing gun.

To use, the operator opens the box end adjacent the tray and removes knock-out holes in the front face of the box. The hoses are then placed through the knock-out openings and tightened to the cylinder's valve fitting from above (discarding the protective shipping tubes) and the valves are opened. The cover is then folded back into the box to close the box and the hoses extend out of the box. Because the box end adjacent the tray has to be opened and closed to open and close the valves for use of the dispensing gun, the box is usually provided with a strap at the opposite box end which does not open. This means that the box is carried with the cylinders upside-down. However, this carton is perfectly acceptable for portable, hand-held, polyurethane froth foam in situ applications such as typically encountered in the building trades.

Different packaging arrangements are used by different manufacturers. Many two-component kit packages use some form of tray with knock-out holes through which the hoses extend after the box is opened and the hoses attached to the cylinder's valved fitting. A two-component polyurethane froth foam box having cylinders equipped with “dip tubes” which extend through the outlet valve from the inside bottom of the cylinder is disclosed in U.S. Pat. No. 6,283,221. The dip tubes allow the cylinders to be placed upright in the box instead of upside down. This carton does not use a tray and has the hoses extend out the side of the box through knock-out plugs.

Cylinders having dip tubes cannot consistently dispense a fluid in an inverted position, and cylinders without dip tubes do not consistently dispense a fluid in an upright position. Moreover, neither type of cylinder evenly dispenses a fluid in a tipped position, (i.e. between an upright and inverted position).

### SUMMARY OF THE INVENTION

The present invention provides a chargeable portable fluid dispensing kit that is not subject to all hazardous material regulations, and can dispense fluid in any orientation. In one embodiment, the kit includes a cylinder defining a total volume, and having a flexible diaphragm dividing the total volume into a dispensing fluid containing volume and a pressure volume. The cylinder has a first valve outside of the cylinder and in fluid communication with the dispensing fluid containing volume, and the cylinder has a second valve outside of the cylinder and in fluid communication with the pressure volume. Advantageously, a fluid can be introduced into the pressure volume through the second valve to increase the pressure in the total volume for dispensing a dispensing fluid disposed in the fluid dispensing volume through the first valve.

A general objective of the present invention is to provide a fluid dispensing kit that is not subject to all hazardous material shipping regulations. This objective is accomplished by providing the cylinder with a second valve that can be connected to a source of pressurized fluid to pressurize the cylinder after the kit has been shipped.

Another objective of the present invention is to provide a fluid dispensing kit that can consistently dispense a fluid in any orientation and can be charged using a non-inert gas. This objective is accomplished by providing a cylinder having a diaphragm dividing the cylinder volume into a dispensing fluid volume and a pressure volume. The diaphragm separates a compressed fluid pressurizing the cylinder volume from the dispensing fluid, and urges the dispensing fluid out of the first valve regardless of the orientation of the cylinder.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a perspective cut away view of a two component fluid dispensing kit incorporating the present invention;

FIG. 2 is a cross sectional view of a cylinder of FIG. 1;

FIG. 3 is a partial cross sectional view of the cylinder of FIG. 2;

FIG. 4 is a top view of the dispensing kit of FIG. 1 with the cover removed; and

FIG. 5 is a bottom view of the dispensing kit of FIG. 1.

### DETAILED DESCRIPTION OF THE INVENTION

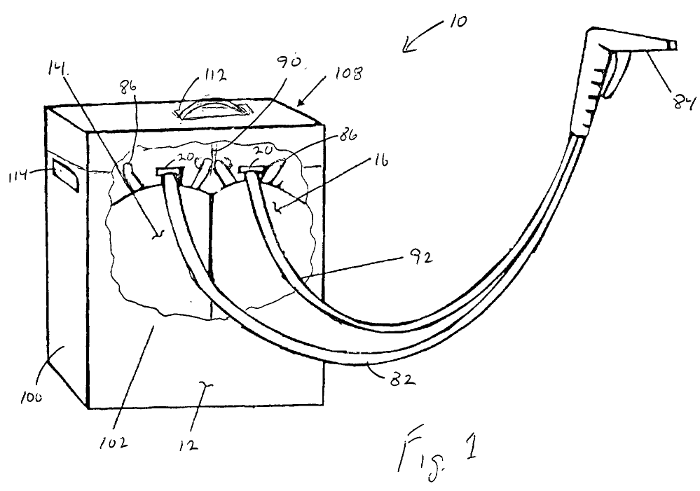

A two-component portable polyurethane foam spray kit 10 contained within a carton 12, shown in FIG. 1, includes two cylinders 14, 16. Preferably, one cylinder, 14 contains an “A” component, such as polymeric isocyanate, and the other cylinder, 16 contains a “B” component, such as polyol amine or resin. Formulations within each cylinder 14, 16 can vary significantly depending on the application. For example, adhesive applications produce a polyurethane foam which has very little, if any, “foam” while insulation applications use a formulation which produces a significant rise in the foam. Usually, portable, hand carried two-component polyurethane foam kits dispense the chemicals from the dispensing gun as a “froth” having a consistency or texture similar to that dispensed from an aerosol can of shaving cream. All such variations in the formulations of polyurethane and whether the chemicals are dispensed as a spray or froth are included within the scope of the present invention so long as the formulations are supplied in a portable, hand carried kit form.

The cylinders 14, 16 are designated by a cylinder diameter, and in one preferred embodiment, the cylinder diameter is 71/2″. Two-component polyurethane foam kits incorporating the present invention can be supplied with cylinders having any diameter, such as between about 6 to 10″ in diameter without departing from the scope of the invention.

In a preferred embodiment described herein, the cylinders 14, 16 have the substantially identical construction. Accordingly, only one cylinder 14 will be described with the understanding that the description applies to the other cylinder 16. Although a two component kit having two cylinders as described below is preferred, substantially identical cylinders are not necessary to fall within the scope of the invention. For example, one of the cylinders can include a dip tube, such as known in the art.

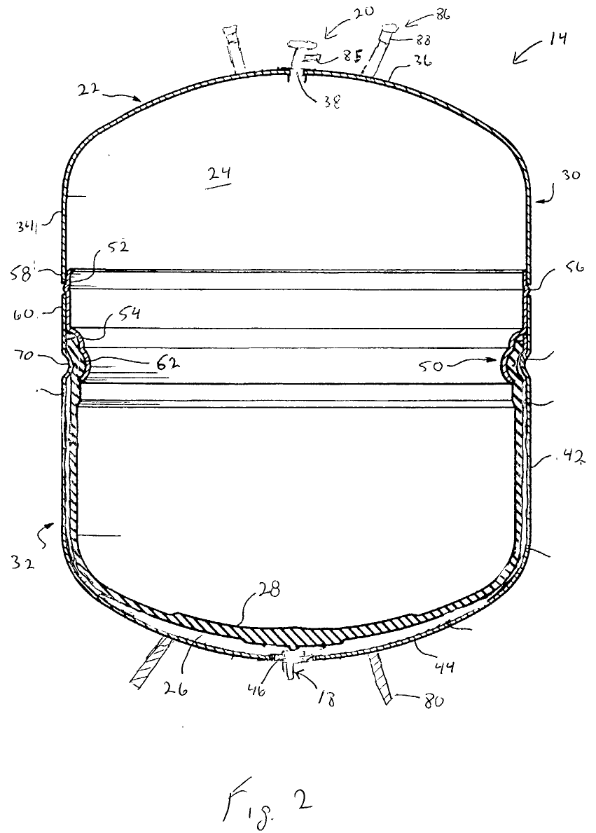

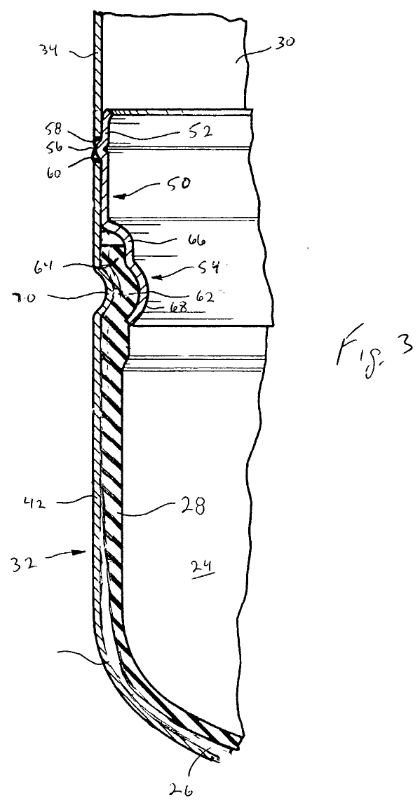

In a preferred embodiment, the cylinder 14 is an expansion tank, such as available from Amtrol Inc., West Warwick, R.I., which has been modified to include the valves 18, 20, as described below. Referring to FIGS. 2 and 3, one embodiment of the cylinder 14 has a cylindrical body 22 that defines a volume. The volume is divided into a variable dispensing fluid volume 24 and a variable pressure volume 26 by a flexible diaphragm 28. In the two component kit 10, the dispensing fluid volume 24 of the cylinder 14 contains one of the “A” and “B” components, and the dispensing fluid volume in the other cylinder 16 contains the other of the “A” and “B” component

The diaphragm 28 is secured in the cylinder 14 to separate the volume into the above described variable volumes 24, 26 using any methods known in the art. In one method, the cylinder 14 includes an upper cylindrical body 30 and a lower cylindrical body 32. The upper cylindrical body 30 has as side wall 34 and an end wall 36 which is provided with an orifice 38. The lower cylindrical body 32 has side wall 42 and an end wall 44 which is provided with an orifice 46.

A retaining (or clamp) ring 50 has an upper portion 52 and a lower portion 54. The upper portion 52 of the retaining ring 50 has a bead (or internally facing groove) 56. A lower edge 58 of the side wall 34 fits tightly over the region of the upper portion 52 above the bead 56, and an upper edge 60 of the side wall 42 fits tightly over the lower portion 54 below the bead 56. The side wall edges 58, 60 are welded to the retaining ring 50 to seal the seam between the upper and lower cylindrical bodies 30, 32.

The flexible diaphragm 28 is preferably formed of butyl rubber or other elastomer, and is disposed inside the lower cylindrical body 32. The diaphragm 28 has an inward protruding bead (or groove) 62 on the interior surface thereof adjacent its circumferential free edge 64. An inward protruding bead (groove) 40 in the side wall 42 corresponds to and mates with the bead 62 of the diaphragm 28. The lower portion 54 of the retaining ring 50 contains an inward slanted portion 66 and an outward facing concave portion 68. The concave portion 68 corresponds to and mates with the bead 62 of diaphragm 28. In this manner, the free circumferential edge 64 of the diaphragm 28 is anchored to the lower cylindrical body 32.

The diaphragm 28 and lower cylindrical body 32 are then put on a grooving machine and a groove 70 is formed into the lower cylindrical body 32, squeezing the diaphragm 28 to sealingly secure the diaphragm 28 to the lower cylindrical body 32. The lower edge 34 of the upper cylindrical body 30 is then forced into fit with the region of upper portion 52 of the retaining ring 50 below the bead 56. The lower edge 58 and upper edge 60 are welded (preferred), brazed or soldered to the bead 56 to seal the seam between the upper and lower cylindrical bodies 30, 32.

Advantageously, the diaphragm 28 separates the dispensing fluid from the pressurizing fluid which allows non-inert gases, such as air, to be used to pressurize, or charge, the cylinder 14. Moreover, when the cylinder 14 is pressurized (i.e. the pressure volume of the cylinder 14 is filled with a pressurizing fluid, such as a liquid or gas), the diaphragm 28 urges the dispensing fluid out of the cylinder 14 through the orifice 38 regardless of the orientation of the cylinder 14. Although a flexible diaphragm, as described above is preferred, any structure that separates the dispensing fluid from the pressurizing fluid, such as a rigid diaphragm, or piston, sealingly engaging the cylinder inner walls and slidable between the cylinder ends, can be provided without departing from the scope of the invention.

A conventional air valve 18, such as a Schrader valve is secured in the orifice 46 in the lower cylindrical body 32, and permits the introduction of a pressurized gas, such as air, into the pressure volume 26 of the cylinder 14. The air valve 18 can be connected to a pressurized source, such as an air compressor, gas cylinder, and the like, proximal the point of use of the kit to pressurize the cylinder 14 by filling the pressure volume 26 of the cylinder with high pressure air. Because the diaphragm 28 separates the pressurized gas in the pressure volume 26 from the dispensing fluid contained in the dispensing fluid volume 24, any pressurized fluid, such as air, carbon dioxide, nitrogen, and the like, can be used regardless of the reactivity of the fluid with the dispensing fluid.

A base 80 extends downwardly from the cylinder 14 surrounding the air valve 18 in the lower cylindrical body 32. The base 80 is stamped from sheet metal and spot or resistance welded to the end wall 44 of the lower cylindrical body 32. Advantageously, the base 80 protects the air valve 18, and supports the cylinder 14 in an upright position when the base 80 is set on a supporting surface. Although a base protecting the air valve is preferred, the base can be omitted without departing from the scope of the invention. In addition other methods for protecting the air valve can be employed, such as by forming a cavity in the end wall surrounding the orifice formed in the lower cylindrical body to protect the air valve, locating the orifice in a side wall of the lower cylindrical body, surrounding the valve with a polystyrene annulus adhesively fixed to the cylinder, and the like, without departing from the scope of the invention.

A conventional fluid dispensing valve 20 is secured in the orifice 38 in the upper cylindrical body 30, and permits the dispensing fluid under pressure to be dispensed through a hose 82 and nozzle 84 connected thereto. The valve 20 opens and closes fluid communication of the dispensing fluid volume 24 of the cylinder 14 with a hose fitting 85. A pressure relief (not shown) can also be provided for the cylinder 14 if required by safety regulations or concerns.

A pair of guards 86 can be provided, as is known in the art, that extends upwardly from the cylinder 14 surrounding the fluid dispensing valve 20. The guard 86 is formed from wire that shaped in a loop and welded to the end wall 36 of upper cylindrical body 30 or valve surrounding the fluid dispensing valve 20. An opening 88 formed in the guard 86 can be used to lift the cylinder 14 and connect the cylinders 24, 16 together using a handle 90. Although a guard 86, or other structure, such as provided for protecting the air valve, protecting the fluid dispensing valve is preferred, it is not necessary to practice the invention.

In the two component kit 10, a hose 82, 92 is connected to each of the fluid dispensing valves 20. Each hose, 82, 92 is connected at its opposite end to a dispensing gun 94. An example of such a gun can be found in U.S. Pat. No. 5,462,204 to Finn, entitled “Foam Dispensing Gun” (incorporated by reference herein) for a description of a dispensing gun used in a two-component system. The invention, however, is not limited to any specific dispensing gun design.

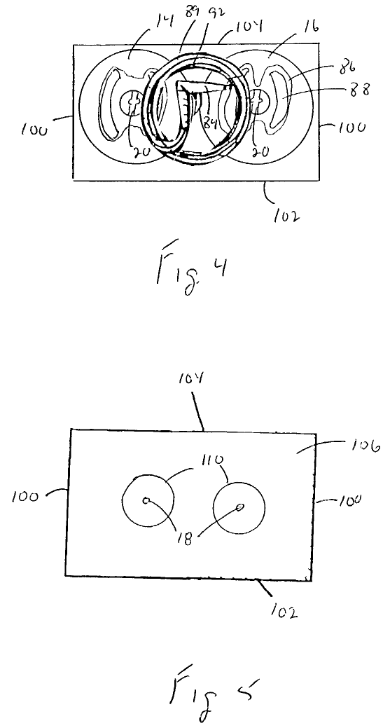

As shown in FIGS. 1, 4, and 5, the carton 12 is a rectangular box, preferably formed from cardboard, such as is known in the art, and provides a convenient carrying case for the cylinders 14 16, hoses, 82, 92, and dispensing gun 84. The carton 12 disclosed herein includes side panels 100 joined by front and rear panels 102, 104 and a closed bottom 106. A cover 108 closes over the carton top and overlaps a portion of the front panel 102. Openings 110 formed in the carton bottom 106 provide access to the air valves 18. Hand openings 114 formed in the carton side panels 100 can be provided for use by the user to carry the kit 10. The handle 90 is connected to the cylinders 14, 16, and extends through an opening 112 formed in the cover 108 when the cover 108 is closed over the top. Advantageously, the cylinders 14, 16 can dispense fluid in any orientation, therefore any known carton can be used, such as known in the art for upright or inverted cylinders, without departing from the scope of the invention.

The portable two component fluid dispensing kit 10 is assembled by slipping the cylinders 14, 16 into the carton 10. The hoses 82, 92 can be connected to the fluid dispensing valves 20 for shipping or be loose for connection to the fluid dispensing valves 20 by the user at the point of use. In one embodiment, the hoses are coiled and fit between the cylinders 14, 16 and a box panel, or can be wrapped around or above the top of the cylinders. The handle is affixed to both cylinders 14, 16 through the opening 88 formed in the guard 86. Of course, a conventional plastic carrying strap, or other type of handle, can be used without departing from the scope of the invention. The cover 108 is then closed over the carton top with the handle 90 extending through the top opening 112. Advantageously, since the cylinders 14, 16 are not under high pressure, many of the hazardous material shipping requirements do not apply.

Once the kit 10 is received at the point of use, the user pressurizes the cylinders 14, 16 by attaching a source of pressurized gas to the air valve 18 in each cylinder 14, 16. Once the pressure in the cylinders 14, 16 reach a desired level, such as between about 80-150 psig at 70° F., the kit 10 is ready for use.

The present invention provides significant advantages over the prior art. The cylinders 14, 16, containing the dispensing fluids can be shipped without regard to regulations regulating hazardous material because the cylinders are not pressurized above pressures that trigger the regulations. In one embodiment, the cylinders 14, 16 can be pressurized proximal the point of use using a pressurizing fluid without regard to the reactivity of the pressurizing fluid with the dispensing fluid because the dispensing fluid and pressurizing fluid are separated in the cylinders.

While there has been shown and described what are at present considered the preferred embodiment of the invention, it will be obvious to those skilled in the art that various changes and modifications can be made therein without departing from the scope of the invention defined by the appended claims. For example, the kit can be a single component fluid dispensing kit containing only one cylinder without departing from the scope of the invention. Therefore, various alternatives and embodiments are contemplated as being within the scope of the following claims particularly pointing out and distinctly claiming the subject matter regarded as the invention.

I claim:

1. A fluid dispensing kit, said kit comprising:
a first cylinder defining a total volume, said first cylinder having a diaphragm dividing said total volume into a dispensing fluid containing volume and a pressure volume, said cylinder having a first valve outside of said cylinder and in fluid communication with said dispensing fluid containing volume, and said cylinder having a second valve outside of said cylinder and in fluid communication with said pressure volume, wherein a fluid can be introduced into said pressure volume through said second valve to increase the pressure in said total volume for dispensing a dispensing fluid contained in said fluid dispensing volume through said first valve.

2. A fluid dispensing kit as in claim 1, in which said cylinder is disposed in a container having front and rear confronting panels inter-connected at their vertically extending edges with side panels to form a generally rectangular chamber within said forward, rearward and side panels, and a top panel for closing the top of said chamber and a bottom panel for closing the bottom of said chamber whereby said container completely encases said cylinder.

3. A fluid dispensing kit as in claim 1, including a dispensing gun and a hose connectable at one end to said first valve and at its opposite end to said dispensing gun.

4. A fluid dispensing kit as in claim 1, including a second cylinder adjacent said first cylinder and defining a second volume, and having a diaphragm dividing said second volume into a dispensing fluid containing volume and a pressure volume, said second cylinder having a first valve outside of said cylinder and in fluid communication with said dispensing fluid containing volume, and said second cylinder having a second valve outside of said second cylinder and in fluid communication with said pressure volume of said second cylinder.

5. The fluid dispensing kit as in claim 4, in which said dispensing fluid volume in said first cylinder contains a resin, and said dispensing fluid volume in said second cylinder contains an isocyanate.

6. The fluid dispensing kit as in claim 1, in which the pressure in said first cylinder is less than 40 psig for shipping.

7. The fluid dispensing kit as in claim 1, in which said diaphragm is flexible.

8. A two component fluid dispensing kit, said kit comprising:
a container having front and rear confronting panels inter-connected at their vertically extending edges with side panels to form a generally rectangular chamber within said forward, rearward and side panels, and a top panel for closing the top of said chamber and a bottom panel for closing the bottom of said chamber.
a first cylinder disposed in said container and defining a total volume, said first cylinder having a diaphragm dividing said total volume into a dispensing fluid containing volume and a pressure volume, said cylinder having a first valve outside of said cylinder and in fluid communication with said dispensing fluid containing volume, and said cylinder having a second valve outside of said cylinder and in fluid communication with said pressure volume, wherein a fluid can be introduced into said pressure volume through said second valve to increase the pressure in said total volume for dispensing a dispensing fluid contained in said fluid dispensing volume through said first valve;
a second cylinder adjacent said first cylinder in said container and defining a second total volume, and having a diaphragm dividing said second total volume into a dispensing fluid containing volume and a pressure volume, said second cylinder having a first valve outside of said cylinder and in fluid communication with said dispensing fluid containing volume, and said second cylinder having a second valve outside of said second cylinder and in fluid communication with said pressure volume of said second cylinder, wherein said dispensing fluid volume in said first cylinder contains a resin, and said dispensing fluid volume in said second cylinder contains an isocyanate.

9. The fluid dispensing kit as in claim 8, including a dispensing gun and a hose for each cylinder connectable at one end to said first valve and at its opposite end to said dispensing gun.

10. The fluid dispensing kit as in claim 8, in which the pressure in said cylinders is less than 40 psig for shipping.

11. The fluid dispensing kit as in claim 8, in which at least one of said diaphragms is flexible.

12. A fluid dispensing kit, said kit comprising:
a first cylinder defining a total volume, said cylinder having a first valve outside of said cylinder and in fluid communication with said volume, and said cylinder having a second valve outside of said cylinder and in fluid communication with said volume, wherein said first cylinder is charged through said second valve to increase the pressure in said volume for dispensing a dispensing fluid contained in said volume through said first valve.

13. The fluid dispensing kit as in claim 12, in which said first cylinder has a diaphragm dividing said volume into a dispensing fluid containing volume and a pressure volume, and said first valve outside is in fluid communication with said dispensing fluid containing volume, and said second valve is in fluid communication with said pressure volume.

14. A fluid dispensing kit as in claim 12, in which said cylinder is disposed in a container having front and rear confronting panels inter-connected at their vertically extending edges with side panels to form a generally rectangular chamber within said forward, rearward and side panels, and a top panel for closing the top of said chamber and a bottom panel for closing the bottom of said chamber whereby said container completely encases said cylinder.

15. A fluid dispensing kit as in claim 12, including a dispensing gun and a hose connectable at one end to said first valve and at its opposite end to said dispensing gun.

16. A fluid dispensing kit as in claim 12, including a second cylinder adjacent said first cylinder and defining a second volume, and having a diaphragm dividing said second volume into a dispensing fluid containing volume and a pressure volume, said second cylinder having a first valve outside of said cylinder and in fluid communication with said dispensing fluid containing volume, and said second cylinder having a second valve outside of said second cylinder and in fluid communication with said pressure volume of said second cylinder.

17. The fluid dispensing kit as in claim 13, in which said dispensing fluid volume in said first cylinder contains a resin, and said dispensing fluid volume in said second cylinder contains an isocyanate.

18. The fluid dispensing kit as in claim 11, in which the pressure in said first cylinder is less than 40 psig for shipping.

19. The fluid dispensing kit as in claim 11, in which said diaphragm is flexible.
